(19) United States
(12) Patent Application Publication
(10) Pub. No.: US 2025/0334472 A1
(43) Pub. Date: Oct. 30, 2025

(54) METHOD FOR MONITORING A CENTRIFUGAL SEPARATOR FOR DRUM LEAKAGE

(71) Applicant: GEA WESTFALIA SEPARATOR GROUP GMBH, Oelde (DE)

(72) Inventors: Tim HUNDERTMARK, Gütersloh (DE); Frank TIPPKEMPER, Arnsberg-Vosswinkel (DE); Heribert GRUENDEL, Telgte (DE); Sven NITSCHKE, Oelde (DE)

(21) Appl. No.: 18/868,413

(22) PCT Filed: Mar. 1, 2023
(86) PCT No.: PCT/EP2023/055112

§ 371 Date: Nov. 22, 2024

(30) Foreign Application Priority Data
May 25, 2022 (DE) 10 2022 113 295.1

(51) Int. Cl. G01M 3/32

(52) U.S. Cl. CPC G01M 3/32

(57) ABSTRACT

A method for monitoring a drum of a centrifugal separator for leakage involves providing the centrifugal separator comprising an emptied drum and providing a value for a reference volume of the drum. A measuring device measures an inflowing volume until the reference volume of the drum is reached. A pressure sensor in the outlet for a phase measures a pressure. A temporal sequence of the measured values of the pressure after the reference volume has been reached is evaluated to determine a pressure rise. If the determined pressure rise occurs outside of a time interval after the reference volume has been reached, a signal is output.

### BACKGROUND AND SUMMARY OF THE INVENTION

Exemplary embodiments of the present invention relate to a method for monitoring a drum of a centrifugal separator for leakage.

When operating a disk centrifuge, it is advantageous to detect leaks, particularly in the area of the so-called main drum seal.

It is desirable to at least regularly check the drum interior for leaks. This ensures that the separator functions properly and improves overall operational safety.

Based on the aforementioned problem, exemplary embodiments of the present invention provide a method for monitoring a drum leakage, in particular during operation and, optionally, quantifying the extent of the leakage.

A method according to the invention for monitoring a drum of a centrifugal separator for leakage has the following steps:
A Providing the centrifugal separator comprising an emptied drum and providing a value for a reference volume of the drum;

Provision can either take place during commissioning or during ongoing operation of the separator by emptying the drum beforehand, as well as subsequent refilling and metrological recording of the feed volume and the pressure in a product discharge of the drum. In the case of commissioning, the provision of the reference volume can be a predetermined design value, which is specified by the manufacturer for the type of separator. Step A is then followed by step B.
B Measuring, by means of a measuring device, an inflowing volume at least until the reference volume of the drum is reached;

In step B, the drum is filled. The inflowing volume, in particular the flushing medium, is recorded until the reference volume is reached. However, measurement is also carried out after the reference volume has been reached, wherein an increase in pressure is now also detected and evaluated by sensors.

A flushing medium in the sense of the present invention can be any liquid without solids, e.g., displacement water or a product phase.

If the pressure rise does not occur exactly when the reference volume is reached, the determined feed volume can be recorded at the time the measured value of the pressure rise is recorded. A new reference volume for filling the drum can be determined and stored from this feed volume.

If, for example, the pressure then continues to rise until a constant overpressure is set at the outlet while the feed volume remains the same, this is a sign that the drum is tight. If no pressure rise is detected at the product outlet of an outgoing phase when the reference volume is reached or if a pressure rise is determined after the time of detection of reaching the reference volume, the volume runs out of the drum at another point. In other words, if the pressure rise is only observed later despite the reference volume being reached, the drum is leaking.
C Measuring a pressure by means of a pressure sensor in the outlet of a phase;
D Evaluating the temporal sequence of the measured values of the pressure after the reference volume has been reached, and thus determining a pressure rise;
and
E Outputting a signal if the determined pressure rise occurs outside of a time interval after the reference volume has been reached.

As can be seen from the above description, individual steps can be carried out at the same time as the respective subsequent steps or can merge directly into the subsequent steps.

The following steps can be used to provide the value for a reference volume of the drum, preferably when the separator is commissioned:
I. Providing a centrifugal separator with a predefined reference volume depending on its geometric dimensions;
II. Filling the drum and determining the volume of liquid required to fill the drum, which corresponds to the currently available free drum volume of the drum, until a limit level is reached.

The limit level can be determined, for example, by a pressure sensor or a limit level switch. Corresponding switches are known from process and measurement technology. They can be vibronic switches or capacitive switches, for example. However, the pressure sensor is preferred as it can also be used to determine the free drum volume, e.g., as an adapted reference volume, or to quantify the extent of the leakage.

The pressure sensor and/or the level switch can be arranged, in particular, at the outlet of the heavier liquid phase or the clarified phase of the separator.

The liquid introduced to fill the drum is preferably a flushing medium, wherein a flushing medium inlet of the separator for filling the drum and a product inlet of the separator flow into a common inlet pipe.

The volume required to fill the drum can advantageously be determined using a flow meter. For conductive media such as water, a magnetic-inductive flow meter is particularly suitable.

The flow meter can be arranged in or at the product inlet of the separator and/or particularly preferably in or at the flushing medium inlet.

If a signal is generated according to step E, the signal generates an output at an output unit, preferably a warning. Alternatively, or additionally, an immediate action can be taken on the operation of the separator, in particular emptying and/or shutting down of the separator can be initiated to prevent further product loss due to leakage and to protect the drum from wear.

Steps A-E can be repeated at least twice, in particular at regular intervals, wherein filling can take place in step B after the drum has been emptied.

At least steps B-E and preferably the entire process should be carried out with the drum rotating.

Another advantage of the method is that the measurement can be carried out online during the process without dismantling.

### BRIEF DESCRIPTION OF THE DRAWING FIGURES

Further advantages, features and details of the invention are shown in the following description, in which an exemplary embodiment of the invention is explained in more detail with reference to the accompanying drawings. The person skilled in the art will also usefully consider the features disclosed in combination in the drawing, the description and the claims individually and combine them to form useful further combinations. In particular, there are a large number of possibilities for modifying and further developing these within the framework of the present invention, wherein:

FIG. 1 shows a perspective view of a separator according to the invention;

FIG. 2 shows a sectional view of the separator according to the invention for carrying out the method according to the invention; and

FIG. 3 shows a schematic representation of the method sequence according to the invention.

### DETAILED DESCRIPTION

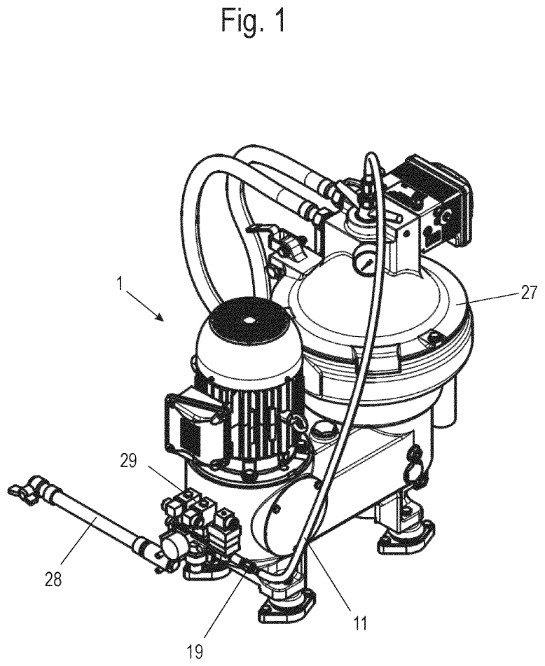

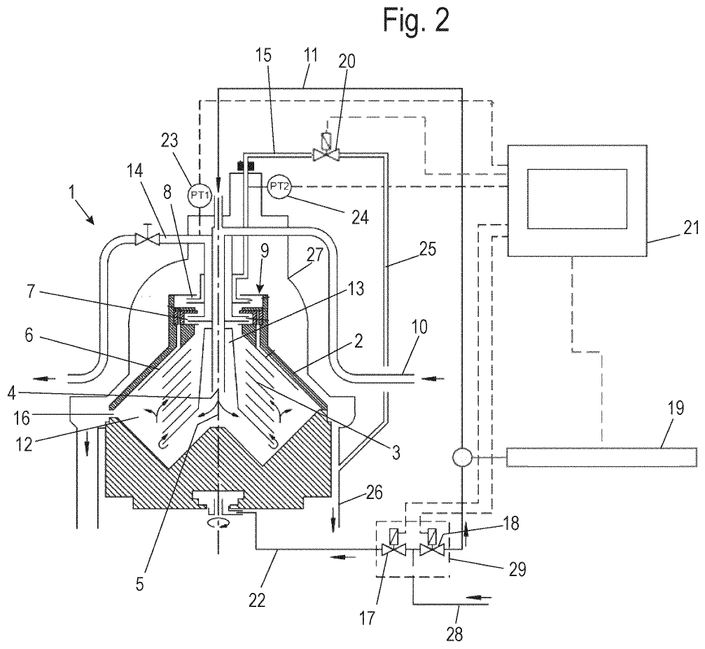

The exemplary embodiment shown in FIGS. 1 and 2 shows a separator 1 with a rotatably mounted drum 2, which has a technical drum volume as a predetermined reference volume.

This drum volume is determined from the dimension of the inner volume 12 of the drum 2, as well as superstructures arranged in the inner volume 12, such as the dimension and number of disks of a disk stack 3 and the distance between them. Furthermore, the size of the technical drum volume includes, among other things, the design of one or more feed areas 4, distribution areas 5, separating plates 6, paring chambers 7, paring disks 8, discharge areas 9, and the like. The above list is by no means exhaustive. Depending on the design, individual structures listed above can be omitted or replaced by other structures without changing the overall principle described below.

The separator 1 also has a product inlet 10 and a flushing medium inlet 11, which flow into a common inlet pipe 13, which in turn at least partially forms part of an inlet area 4 in the inner volume 12 of the drum 2.

Furthermore, the separator 1 has a first outlet 14 for a light liquid phase, a second outlet 15 for a heavy liquid phase and a solids outlet 16 as part of a solids discharge system. The separator 1 is recognizably designed as a three-phase separator.

However, the following principle can also be applied to a two-phase separator, e.g., a clarifier.

The separator 1 shown in FIGS. 1 and 2 has a respective pressure sensor 23 and 24 at the first and second outlet 14 and 15 of the liquid phases. These pressure sensors 23 and 24 typically enable process monitoring during the separation of a light and a heavy phase, such as the purification of water in oil.

Within the scope of the present invention, however, it is also possible to determine a reference volume and a leakage by means of the aforementioned sensors.

In addition, the separator 1 also has a control water inlet 22, which is provided for controlling the solids discharge or the solids emptying, e.g., by hydraulically actuated linear displacement of a piston slide as part of a solids emptying system. A water inlet 28 of the separator 1 branches into the two aforementioned water inlets 11 and 22. However, as already mentioned, the inlets 11 and 22 can also be led separately to the separator. There is therefore no restriction to the aforementioned configuration.

The supply of the quantity of flushing medium into the first flushing medium inlet 11 is controlled by a valve arrangement 29, in FIG. 2 specifically by valve 18. These can preferably be solenoid valves. Of course, the two valves 17 and 18 can also be combined in a multi-port valve, so that the valve arrangement 29 can also comprise just one valve.

The quantity and/or volume of flushing medium supplied through the flushing medium inlet 11 is determined by a corresponding measuring device 19, preferably a flow meter. In particular, this can be arranged in the flushing medium inlet 11.

The second outlet 15 for the heavy phase preferably also has a valve 20, preferably a solenoid valve.

The measured values determined by the measuring device 19, as well as the measured values of the pressure sensors 23 or 24, can be transmitted to a control and/or evaluation unit 21, which then controls the valves 17 and 18 for the control and flushing medium and the valve 20 for the heavy phase.

The aim of measuring the flow rate of flushing medium and the associated valve control is to determine an adjusted reference volume.

The determined reference volume can be compared with the initial reference volume specified by the manufacturer or the actual free volume (e.g., calculated from the geometry or determined in tests). The free drum volume (technical drum volume) depends on the machine type (size of the drum, number and spacing of the disks, etc.) and is stored in the machine control system. The degree of soiling of the drum can then also be determined from the comparison.

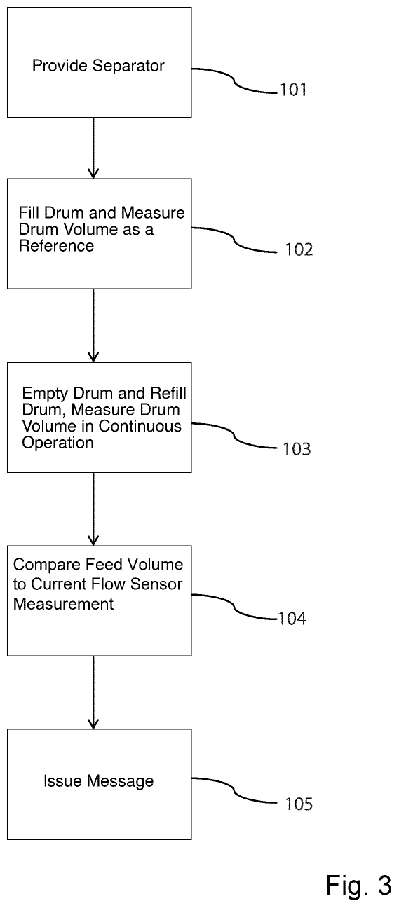

The determination of a leakage requires several steps, as shown in FIG. 3.

A first step 101 is to provide a separator with an empty drum and closed inlet and outlet. Depending on the design, an initial value for a reference volume or a reference pressure is available for the separator when the drum is filled for the first time.

During commissioning, the volume of the drum can be measured for the first time. For this purpose, after reaching the nominal speed, the drum is filled in step 102 until a defined pressure rise is detected at the pressure transmitter in one of the respective phases. The volume is stored in the drum as an adjusted reference volume. Flushing medium in particular can be used for filling. The drum is filled by opening the valve 18 until the gripper 8 dips into the water and the pressure at the pressure sensor 24 increases. In this way, the filling volume of liquid for filling the drum volume is determined by the measuring device 19, preferably a flow meter, in particular an EMF.

The determined drum volume can be saved as an adjusted reference value. If this newly determined reference value exceeds a limit level, for example 20% of a previously stored reference value, i.e., if the drum is 20% overfilled, an increase in pressure should typically be observed at the outlet of one of the phases at pressure sensor 24. If this is not the case, a drum leakage message is issued.

The centrifugal separator can then be operated continuously, e.g., to process a product. In continuous operation, the drum can be completely or partially emptied again in a third step 103 after a predefined time interval and the measurement can be carried out again by introducing flushing medium, analogous to step 102. The inflowing volume is determined by the flow meter 19 and the reference volume can be adjusted again. The pressure sensor detects an increase in pressure.

Finally, in a fourth step 104, the feed volume is compared as a reference value against the current measurement with the flow sensor 19. If there is no pressure rise after the adjusted reference value of the drum volume is reached, a message 105 is issued regarding a leak.

If, for example, no pressure is displayed when filling to 20% above the reference volume, an error should be displayed immediately.

If the pressure rises, valve 18 can be opened again after 5 minutes, for example, and it is checked whether a pressure rise is immediately detected at pressure sensor 24. If this is not the case, a warning “Check drum seal” can be issued

The measurement can therefore also be carried out at regular intervals while the separator is in operation. For this purpose, either a total emptying or several partial emptying operations are carried out. A pressure measurement can then be started as described above.

### LIST OF REFERENCE SIGNS

1 Separator
2 Drum
3 Disk stack
4 Inlet area
5 Distribution area
6 Separation plate
7 Gripper chamber light phase
8 Gripper chamber heavy phase
9 Discharge area
10 Product inlet
11 First flushing medium inlet
12 Inner volume
13 Inlet pipe
14 First outlet (light phase)
15 Second outlet (heavy phase)
16 Solids outlet
17 Valve
18 Valve
19 Measuring device
20 Valve
21 Control and/or evaluation unit
22 Control water inlet
23 Pressure sensor
24 Pressure sensor
25 Bypass tube
26 Solids collection area
27 Separator hood
28 Water inlet
29 Valve arrangement
101 First step (commissioning)
102 Second step (first determination of a reference volume)
103 Third step (repetition during operation)
104 Fourth step (comparison & output)
105 Message

1-12. (canceled)

13. A method for monitoring a drum of a centrifugal separator for leakage, the method comprising:
A. providing the centrifugal separator comprising an emptied drum and providing a value for a reference volume of the drum;
B. measuring, by a measuring device, an inflowing volume into the emptied drum at least until the reference volume of the drum is reached;
C. measuring a pressure using a pressure sensor in an outlet of the drum for a phase;
D. evaluating a temporal sequence of measured values of the pressure after the reference volume has been reached to determine a pressure rise; and
E. outputting a signal responsive to the determined pressure rise occurring outside of a time interval after the reference volume has been reached.

14. The method of claim 13, wherein the providing of the value for the reference volume of the drum comprises:
I. providing the centrifugal separator with a predefined reference volume depending on geometric dimensions of the centrifugal separator; and
II. filling the drum and determining a volume of liquid required to fill the drum, which corresponds to a currently available free drum volume of the drum, until a limit level is reached.

15. The method of claim 14, wherein the limit level indicates a maximum filling of the drum and the limit level is detected by one or more pressure sensors or by a limit level switch in the outlet of the phase.

16. The method of claim 15, wherein the one or more the pressure sensors or the limit level switch is arranged at an outlet of a heavier liquid phase of the separator.

17. The method of claim 13, wherein the inflowing volume is a liquid that is flushing medium, wherein a flushing medium inlet of the separator for filling the drum and a product inlet of the separator open into a common inlet pipe.

18. The method of claim 13, wherein the reference volume is determined by a flow meter.

19. The method of claim 18, wherein the flow meter is arranged in or at a product inlet of the centrifugal separator.

20. The method of claim 13, wherein the signal initiates an output at an output unit or the signal initiates performance of an immediate action on operation of the centrifugal separator.

21. The method of claim 13, wherein steps A.-E. are repeated at least twice, wherein in step B. a partial or complete filling occurs after a partial or complete emptying of the drum.

22. The method of claim 13, wherein at least steps B.-E. are performed while the centrifugal separator is rotating.

23. The method of claim 13, wherein an extent of the leakage is determined and output by evaluating the pressure rise and the volume supplied within a time interval.

24. The method of claim 13, wherein an entirety of the method is performed without dismantling the centrifugal separator.
